(19) United States
(12) Patent Application Publication
(10) Pub. No.: US 2009/0117213 A1
(43) Pub. Date: May 7, 2009

(54) Stable solutions having antiviral, antibacterial and hemostatic properties and methods of making thereof

(76) Inventors: Clermont Beaulieu, Le Bic Quebec (CA); Arnold Blais, Gaspe Quebec (CA)

Correspondence Address: RYAN KROMHOLZ & MANION, S.C., POST OFFICE BOX 26618, MILWAUKEE, WI, 53226, US

(21) Appl. No.: 11/982,997

(22) Filed: Nov. 6, 2007

(51) Int. Cl. A01N 65/00; A01N 43/04; A01P 1/00; B65D 5/72; B43K 19/00

(52) U.S. Cl. 424/769; 514/55; 222/575; 401/49

(57) ABSTRACT

Chitosan/alcohol solutions being stable solutions that have antiviral, antibacterial and hemostatic effects and methods of making thereof. The solutions can be liquids or gels and can be delivered in variety of manners.

### BACKGROUND OF THE INVENTION

The present invention relates to solutions that have antiviral, antibacterial and hemostatic properties. More particularly, the present invention relates to solutions having antibacterial and hemostatic properties that incorporate a chitosan agent into the solution.

Various forms of antibacterial compositions containing alcohols are known in the art and have been used in the healthcare industry for some time. The antibacterial compositions are typically utilized to cleanse the skin and destroy bacteria and other microorganisms present thereon, especially on the hands, arms, and face of the user.

Antibacterial compositions in general have been used in the healthcare industry, food service industry, meat processing industry, and in the private sector by individual consumers to control and prevent the spread of potentially harmful microorganisms. The widespread use of antibacterial compositions indicates the importance of controlling bacteria and other microorganism populations on the skin or other substrates. It is important, that the antibacterial compositions reduce microorganism populations rapidly, without irritating or damaging skin or having a detrimental toxicity.

Antibacterial solutions may also be used on or near cuts, abrasions, or wounds located on the skin. In such instances, it is also important to stop or control potential bleeding associated with cut or abrasion. Solutions having hemostatic properties would be beneficial as well.

### SUMMARY OF THE INVENTION

The present invention comprises solutions having antiviral, antibacterial and hemostatic properties that further comprise chitosan and alcohol based materials. The solutions may be either liquid or gel-like, depending on the amount of alcohol and chitosan within the solution.

The invention further contemplates delivery devices for the antiviral, antibacterial and hemostatic solutions of the present application and methods of producing the antiviral, antibacterial and hemostatic solutions.

### BRIEF DESCRIPTION OF THE DRAWINGS

FIG. 1 is a perspective view of a magnetic stirrer and beaker, which demonstrates an initial step of wetting and dispersion in water.

FIG. 2 is another perspective view of the stirrer and beaker of FIG. 1, demonstrating a step of wetting and dispersing chitosan, in powder or flake form, into the beaker of FIG. 1.

FIG. 3 is a further perspective view of the stirrer and beaker of FIG. 1 including a rotor and motor, demonstrating a mixing step.

FIGS. 4 and 5 provide perspective views of a beaker and a rotor and a motor, demonstrating the gradual dissolution of the dispersed chitosan following slow addition of an acid. On reaching a pH between 2-4 and complete dissolution of the chitosan, a basic solution is slowing added to bring the final pH back to 4.5-5.0. The pH of the mixture is monitored continuously by a pH electrode during the additions.

FIG. 6 provides a further perspective view of the beaker shown in the previous Figures, with the concentration of the solution being adjusted by adding deionized water to the solution.

FIG. 7 provides a perspective view of a second, larger beaker than that shown in FIGS. 1-6, with the solution described and shown in FIGS. 1-6 being transferred into the larger beaker.

FIG. 8 is a perspective view of the beaker of FIG. 7, further demonstrating a mixing step for the solution wherein an alcohol solution is added to the solution of FIG. 7.

FIG. 9 is a front plan view of a container that will store the final solution from FIG. 8.

FIG. 10 is a perspective view of a beaker used to demonstrate a first step of adding chitosan for a second method for mixing a chitosan/alcohol solution according to the present invention.

FIG. 11 is a further step for the second method depicted in FIG. 10, showing water being added to the beaker shown in FIG. 10.

FIG. 12 provides a further step for the second method depicted in FIG. 10 to regulate the pH of the solution.

FIG. 13 further depicts a step of regulating the pH for the second method shown in FIG. 10.

FIG. 14 is a perspective view of the beaker of FIG. 10, demonstrating a mixing step wherein an alcohol solution is added to the beaker.

FIG. 15 is a perspective view of a Petri dish, with the Petri dish depicting an untreated biofilm comprising an exemplary bacteria culture.

FIG. 16 is a perspective view of the Petri dish of FIG. 15 being treated with a solution according to the present invention.

FIG. 17 is a perspective view of the Petri dish of FIGS. 15 and 16 after being treated by the solution as shown in FIG. 16.

FIG. 18 graphically depicts various bacteria (with the chitosan solution being ranked on a scale of bactericidal efficacy, ranked from 0 to 3) that have been treated with solutions developed according to the present invention after 24 and 48 hours.

FIG. 19 graphically depicts the inhibitory effect of a solution, developed according to the present invention, upon a produced water biofilm 22 hours after a 1 hour treatment.

FIG. 20 graphically depicts the % logarithmic inhibitory effect of a solution, developed according to the present invention, upon a produced water biofilm 22 hours after 1 hour of treatment.

FIG. 21 graphically depicts the inhibitory effect of a solution, developed according to the present invention, upon a produced water biofilm 48 hours after 1 hour of treatment.

FIG. 22 graphically depicts the % logarithmic inhibitory effect of a solution, developed according to the present invention, upon a produced water biofilm 48 hours after 1 hour of treatment.

FIG. 23 graphically compares a solution, developed according to the present invention, to a control solution, depicting the bacteria count on a treated water biofilm 22 hours after 1 hour treatment.

FIG. 24 graphically compares a solution, developed according to the present invention, to a control solution, depicting the bacteria count on a treated water biofilm 48 hours after 1 hour treatment.

FIG. 25 graphically depicts the inhibitory effect of a solution, developed according to the present invention, on a produced water biofilm after one (1) hour of treatment, with the effect demonstrated in percent of bacteria inhibited.

FIG. 26 graphically depicts the effect of a solution, developed according to the present invention, invention on a produced water biofilm after one (1) hour of treatment compared with a control solution, with the effect demonstrated as the bacteria count on the biofilm.

FIG. 27A graphically depicts the absence of change over 24 hours in solutions having various amounts of chitosan material within the solution, developed according to the present invention, on a no bacteria blank control.

FIG. 27B graphically depicts a correlation in bacterial inhibition with chitosan concentration of the solutions shown in FIG. 27A on the bacteria P. aeruginosa over 24 hours of contact with the bacteria.

FIG. 27C graphically depicts a second experiment demonstrating reproducibility of the inhibitory effect of the solutions shown in FIG. 27A on the bacteria P. aeruginosa over 24 hours of contact with the bacteria.

FIG. 28 graphically depicts the effects of a solution developed according to the present invention on Escheria Coli (E. Coli) after being left under a sterile hood for 12 hours and allowed to dry.

FIG. 29 graphically depicts the effects of a solution developed according to the present invention on Escheria Coli (E. Coli) after being left under a sterile hood for 18 hours and allowed to dry.

FIG. 30 graphically depicts the effects of a solution developed according to the present invention on Escheria Coli (E. Coli) after being left under a sterile hood for 24 hours and allowed to dry.

FIG. 31 graphically depicts the effects of a solution developed according to the present invention on Staphylococcus aureus (S. aureus) after being left under a sterile hood for 12 hours and allowed to dry.

FIG. 32 graphically depicts the effects of a solution developed according to the present invention on Staphylococcus aureus (S. aureus) after being left under a sterile hood for 18 hours and allowed to dry.

FIG. 33 graphically depicts the effects of a solution developed according to the present invention on Staphylococcus aureus (S. aureus) after being left under a sterile hood for 24 hours and allowed to dry.

FIG. 34A graphically depicts the absence of change of spore growth of B. Subtilis over 24 hours in solutions having various amounts of chitosan material within the solution, developed according to the present invention, on a no spore blank control.

FIG. 34B graphically depicts a correlation in spore growth of B. Subtilis inhibition with chitosan concentration of the solutions shown in FIG. 34A on the spore growth of B. Subtilis over 24 hours of contact with the spore.

FIG. 35 graphically depicts the effect of solutions having various amounts of chitosan material within the solution, developed according to the present invention, on spore growth for of B. Subtilis 18 hours and 24 hours.

FIG. 36 graphically depicts the effect of solutions having various amounts of chitosan material within the solution, developed according to the present invention, on spore growth B. Subtilis for 18 hours and 24 hours, after the materials have been incubated for at least 42 hours.

FIG. 37 shows a spray bottle containing a solution prepared according to the present invention.

FIG. 38 is a perspective view of a spray bottle containing a solution according to the present invention, with the solution being sprayed on a doorknob.

FIG. 39 is a perspective view of a spray bottle containing a solution according to the present invention, with the solution being sprayed on a surgical mask.

FIG. 40 is a perspective view of a spray bottle containing a solution according to the present invention, with the solution being sprayed on a menu.

FIG. 41 is a perspective view of a spray bottle containing a solution according to the present invention, with the solution being sprayed on a person's hands.

FIG. 42 is a perspective view of the person's hands shown in FIG. 31 being rinsed with water to remove the solution applied in FIG. 41.

FIG. 43 is a perspective view of a spray bottle containing a solution according to the present invention, with the solution being added to a bandage.

FIG. 44 is a perspective view of a lip balm style container, with the container holding a solution according to the present invention.

FIG. 45 is a perspective view of the container of FIG. 44 being utilized by a person to apply a solution according to the present invention onto the person's face.

FIG. 46 is a perspective view of an applicator, including a fluid reservoir that houses a solution according to the present invention, with the applicator being used to apply a solution according to the present invention.

FIG. 47 is a perspective view of a person accessing the fluid reservoir of the applicator of FIG. 46.

FIG. 48 demonstrates a person moving the solution from the fluid reservoir of the applicator towards the applicator portion of the applicator of FIG. 46.

FIG. 49 is a perspective view of the applicator of FIG. 46 being used to apply a solution according to the present invention onto a wound area.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The present invention provides an improved liquid solution having antiviral, antibacterial and hemostatic properties and, also, is a stable product over an extended period of time. The present invention also provides significant advantages over other broad-spectrum antibacterial treatments in that it has relatively low cytotoxicity to eukaryotic cells and organisms (bacteria are prokaryotic cells). The present invention has also been found to have efficacy against viruses such as HIV and Herpes. Generally, the solution is an alcohol based solution that incorporates a chitosan material into the solution. Preferably (to further reduce cytotoxicity), the solution has a relatively low concentration of alcohol and preferably has alcohol concentrations below 35% v/v. Chitosan materials used in the solutions preferably have relatively low molecular weights and relatively high levels of deacetylation, which, when combined with alcohol, provides an antiviral, antibacterial and hemostatic solution that has an extended efficient shelf life that has multiple and various uses, such uses against infection on humans and on inanimate objects, hemostatic treatment of cuts, abrasion, and the likes on skin, inhibition of biofilm accumulation and killing of bacteria in pre-accumulated biofilms, such as biofilms that may occur in water treatment systems, and other various uses. These solutions have been occasionally referred to as “kitomer” solutions. It should be understood that reference to a kitomer solution is reference to a chitosan solution developed in accordance with the present invention and should not be limited to any specific level or amount of chitosan or alcohol concentration with the solutions. To demonstrate the solutions, methods, and devices of the present invention, the application has been divided into three sections:
I. The Solution and Its Physical Properties
   A. Preparation of the Solution
   B. Physical Properties of the Solutions
      1. Sprayable Solutions
      2. Chitosan Gels
II. Analysis of the Properties and Qualities of the Solution; and
   A. Analysis of the Solutions on Biofilms
   B. Analysis of the Solutions on Combating Bacteria and Other Microbes
   C. Hemostatic Properties of the Solutions
   D. Conclusion
III. Uses and Products Incorporating the Solutions of the Present Invention
   A. Liquid Chitosan/Alcohol Solutions
   B. Chitosan Gel Solutions and Delivery Devices
      These three sections will demonstrate the various features and novelties of the invention, but should not limit what the inventors consider as their invention.

### I. The Solution and its Physical Properties

The first section of this application provides an overview of the chemical makeup of the chitosan/alcohol solutions according to the present invention, divided into two areas:

A. Preparation of the Solution; and

B. Physical Properties of the Solutions

These areas will be described in further detail below.

A. Preparation of the Solution

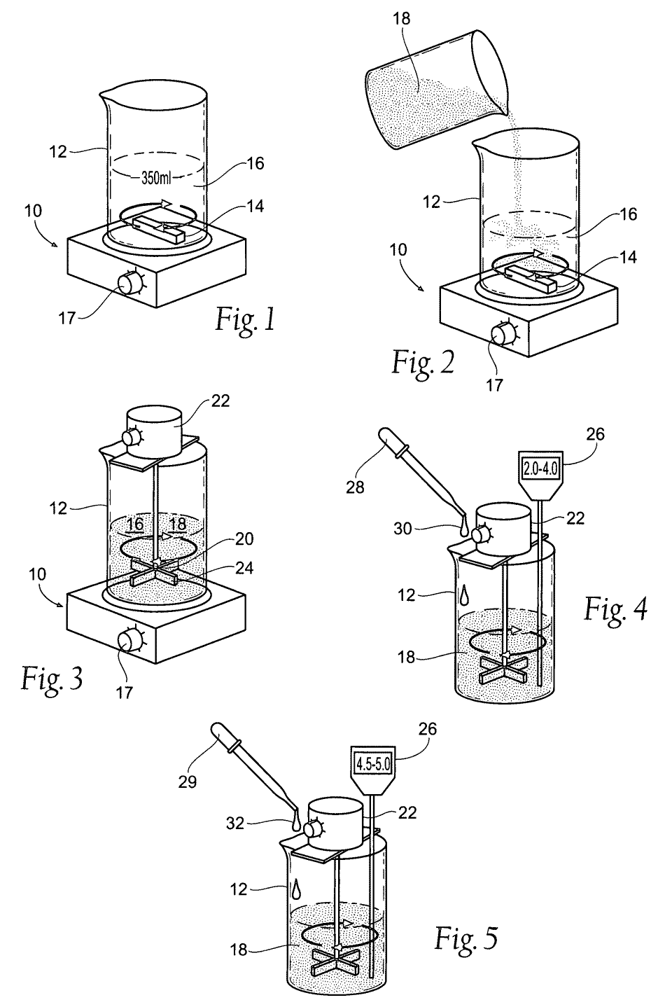

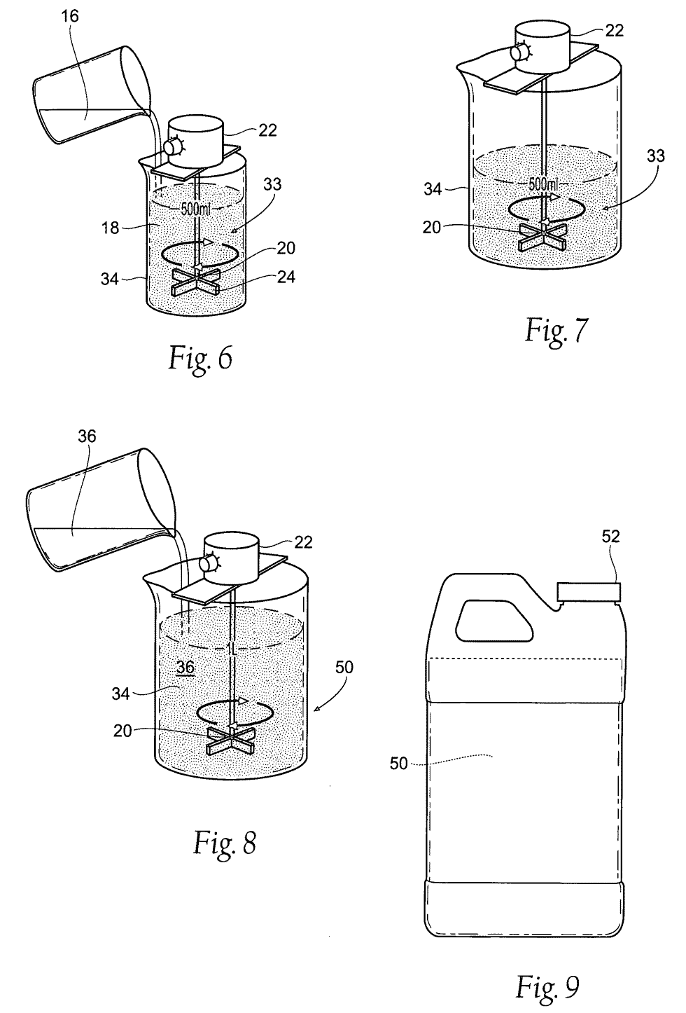

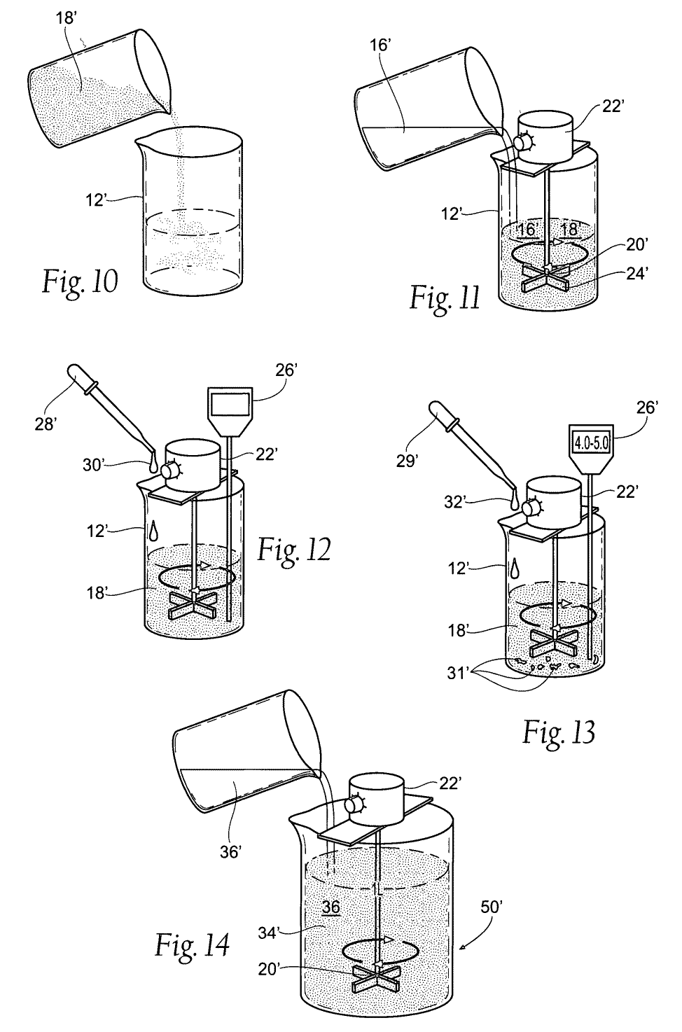

FIGS. 1-9 demonstrate a preferred method of preparing a solution or formulations according to the present invention. However, it is understood that other methods and processes can be used to prepare the solutions of the present invention and will fall within the scope of the present invention.

FIG. 1 provides a magnetic stirrer 10, commonly known and used in the art, to provide the necessary initial agitation of the process. The stirrer 10 supports a beaker 12, preferably a 1-liter beaker, with a magnetic bar 14 placed within the beaker 12 to assist in agitation of the process. The beaker 12 is filled with deionized water 16, with a control 17 on the stirrer 10 being set to an initial medium speed.

In FIG. 2, 15 grams of a chitosan material 18 is shown being added to the deionized water. The chitosan material 18 is a powder or flake material commercially purchased from a vendor, such as Primex, Ltd. The preferred chitosan material 18 is an ultrapure grade, has a low molecular weight, preferably less than 1000 kDa, more preferably less than 500 kDa, and most preferably less than 100 kDa. Using a chitosan material having a low molecular weight allows more chitosan to be added to the solution, which increases the antiviral, antibacterial and hemostatic effects of the solution. One such chitosan material 12 is sold under the trade name Kitomer. The chitosan material 18 also has a high degree of deacetylation, preferably greater than or equal to 75% deacetylated, more preferably greater than or equal to 85% deacetylated, and most preferably greater than or equal to 95% deacetylated. As with low molecular weights, the highly deacetylated chitosan material also increases the anti-viral, antibacterial and hemostatic effects of the material. The chitosan powder or flake 18 is gradually stirred into the water 16 until it is uniformly dispersed. Once the chitosan 18 is dispersed, the stirrer 10 will continue agitating the water 16/chitosan 18 mixture, for approximately one or two minutes until the chitosan 18 is dispersed in the water 16.

After this initial addition, the magnetic bar 14 is removed from the dispersion and the beaker 12. As shown in FIG. 3, a rotor 20 attached to a motor 22 is inserted into the beaker 12. The rotor 20 and motor 22 are standard as used and understood in the art, with the paddles 24 of the rotor 20 preferably being positioned in the bottom third of the beaker 12, with the paddles 24 preferably positioned so that they are located about 1 or 2 cm away from the surface of the beaker 12. As further shown in FIG. 4, a pH meter 26 is placed within the beaker 12. Agitation of the dispersion should then resume.

FIG. 4 shows the slow addition of a mono-acid (typically hydrochloric 12N, glacial acetic or glycolic acids) to the dispersed chitosan which provides for gradual dissolution of the chitosan to form an aqueous solution. Preferably the dispenser 28 is filled with an acid 30, such as hydrochloric acid (HCl, 12N) which is slowly added to the beaker 12. The dispenser 28 can be any suitable device that will allow slow addition of the acid 30, such as an eye-dropper or a buret. The acid 30 will be added until the pH on the pH meter 26 is between around 2.0 and 4.0. Possible acids to add to the solution include acetic, lactic, glutamic, glycolic, ascorbic, citric, succinic, tartaric, malic, phosphoric, and other similar acids that could be used to regulate the pH and viscosity of the solution. Agitation during the addition of the acids should be constant, so that there is uniform dissolution of the chitosan material 18. Generally mono-acids such as hydrochloric, acetic, glycolic & lactic are used alone or in combination with each other when lower viscosity solutions are required. Di-acids (such as succinic, malic, malonic, tartaric, or other similar acids) and tri-acids (such as citric acid and like acids), which ionically combine with, and cross-link the positively charged chitosan polymer chains, will generally cause increased viscosity and gelation in the chitosan solution. The mono-acids are added first to provide for dissolution. Di-acids, tri-acids and higher acids generally are added subsequently to raise viscosity when thicker solutions are desired.

FIG. 5 shows the pH being further regulated by using a base 32, such as a 1.0 M sodium hydroxide solution (NaOH). The base 32 is slowly added to the beaker 12, drop by drop with a device 29, such as an eye-dropper or a buret, until the pH on the pH meter 26 is between about 4.5 and 5.0. Other bases, such as potassium hydroxide (KOH), lithium hydroxide (LiOH), or other commonly known bases, can be used in place of the sodium hydroxide. When the base 32 is added to the beaker 12, there is a possibility that the base 32 may induce chitosan precipitation. In such an instance, addition of the base 32 should be halted and the speed of the rotor 20 should be increased until the precipitate is completely dissolved.

FIG. 6 shows the beaker 12 after the target pH of FIG. 5 is reached. At this point, more deionized water 16 is added to the beaker 12 until the total volume within the beaker 12 is 500 mL. Agitation is continuous with the rotor 20 during the process. The resultant solution 33 contains approximately 3.0% (w/v) chitosan material 18, which will be further mixed and regulated, as shown in FIG. 7-9.

The solution 33 of FIG. 6 is added to a larger beaker 34, such as a 2-liter beaker, in FIG. 7. The rotor 20 and motor 22 will be used to agitate the solution 32, with the rotor 20 speed being set at a relative medium speed.

As shown in FIG. 8, a secondary solution 36 will be added to the solution 33 approximately 500 ml of the secondary solution 36, so that the final solution 50 equals 1 (one) liter. The rotor 20 is continuously used for agitation while adding the secondary solution 36, with the speed increased, if necessary, so that the secondary solution is completely mixed with the solution 33 The final solution carried out according to FIGS. 1-8 will contain 1.5% (w/v) chitosan material 18.

The secondary solution 36 comprises an alcohol based solution. The secondary solution 36 preferably is either a solution containing 70% isopropyl alcohol, a solution containing 50% ethyl alcohol (also referred to as ethanolic alcohol or ethanol), or a Witch Hazel solution, which contains 14% ethanol and is USP Grade. Use of the Witch Hazel enhances the final solution 50 by providing an enhanced soothing quality to counteract any stinging or irritation from the alcohol within the solution 50. The secondary solution 36 will be added to the beaker 34 in the same fashion for all three secondary solutions 36.

Once the final solution 50 is sufficiently mixed, the solution 50 will be transferred to a storage container 52, as shown in FIG. 9. The storage container 52 is preferably an opaque, closable, hermetically sealable container, which will prevent evaporation of the alcohol within the solution 50. The storage container 52 is preferably stored in a cool place, approximately at a temperature of about 20° C., to further prevent evaporation of alcohol within the solution 50, which would affect the efficacy of the solution.

Three sample solutions prepared according to the above process are listed in Table 1.

TABLE 1
Sample Solutions

| | Chitosan | Molecular | Chitosan | Alcohol |
|---|---|---|---|---|
| Solution | (% w/v) | Weight(kDa) | deacetylation | Concentration |
| A | 1.5% | 150-300 | 95% | 25% v/v ethyl |
| | | | | alcohol |
| B | 1.5% | 150-300 | 95% | 50% v/v Witch |
| | | | | Hazel |
| | | | | distillates |
| C | 1.5% | 150-300 | 95% | 35% v/v |
| | | | | isopropyl |
| | | | | alcohol |

As previously noted above, the process described in FIGS. 1-9 is merely exemplary of processes to form a therapeutic chitosan solution according to the present invention. The mixing process may be altered depending on the scale of the overall mixing process. Likewise, the mixing process may need to be altered if the concentrations of the chitosan and alcohol within the solution are changed.

FIGS. 10-14 provide a second method for mixing and forming a chitosan/alcohol solution according to the present invention. FIG. 10 provides a beaker 12′ that will receive a chitosan material 18′. The beaker 12′ is preferably a 250 ml beaker, but other sizes of beakers can be used. 1.5 grams of dry chitosan material 18′ are added to the beaker 12′

In FIG. 11, distilled water 16′ is added to the beaker 12′. A mixer 24′ is used to mix the water 16′ and the chitosan material 18′, with the mixing time being in the range of about 1 minute.

FIG. 12 depicts a first step of regulating the pH of the chitosan 18′/water 16′ mixture. A pH meter 26′ is placed within the beaker 12′ to monitor the pH level of the mixture. A dispenser 28′, such as an eye dropper or a buret, is used to add an acid 30, such as hydrochloric acid (HCl) (37% v/v or 12N) to the mixture. Approximately 2-5 mL of the acid 30 will be added to the mixture. Continue stirring the mixture until the chitosan material 18′ is completely dissolved, with the time needed for the chitosan material 18′ to completely dissolve dependent on the molecular weight of the chitosan material 18′ used.

FIG. 13 provides a further step of regulating the pH of the chitosan 18′/water 16′ mixture. A second dispenser 29′, similar to the dispenser 28′, will be used to add a basic solution 32′, such as a very dilute sodium hydroxide (NaOH) (0.1 N) or potassium hydroxide (KOH) (0.1 N), to the chitosan 18′/water 16′ mixture. Preferably, no more than 25 ml of the basic solution 32′ is added to the chitosan 18′/water 16′ mixture. The addition of the basic solution 32′ will cause the chitosan material 18′ to form precipitated clumps 31′ within the mixture. To combat these clumps 31′, the mixer 24′ must be sufficiently strong to break up the clumps 31′. Basic solution 32′ will be added until the pH of the solution is preferably between about 4.0 and 5.0. Mixing will continue until the clumps 31′ are completely dissolved in the chitosan 18′/water 16′ mixture, with mixing time being between approximately 30 minutes and 3 hours.

Once the protocol above has been carried out sufficiently, it is possible to calculate the basic solution 32′ to be added to the chitosan 18′/water 16′ mixture so that the necessary pH is reached. That is, a person will be able to accurately calculate the basic solution 32′ needed once the process has been performed consistently. The key is to mix the mixture sufficiently so that the chitosan material 18′ is completely dissolved within the mixture.

After dissolution of the chitosan material 18′, approximately 25 ml of a secondary solution 36′, such as pure ethanol, will be added to the chitosan 18′/water 16′ mixture and gently agitated. The resultant solution 50′ provides an antiviral, antibacterial and hemostatic solution according to the present invention. The present example results in 100 ml of solution 50′ containing 1.5% (w/v) chitosan material 18′ and 25% (v/v) ethanol.

Depending on the use of the chitosan/alcohol solution, the solution may undergo sterilization. For instance, the solution may be processed with sterile filtration or autoclaving. Aseptic preparation of the solution may also be possible by using sterilized chitosan material (i.e. chitosan material that has been gamma-irradiated or sterilized in some other fashion) and sterile filtered aqueous solutions.

The solutions may further be adapted as is desired for specific needs. For instance, to improve surface wetting properties and softness of the solution 50 when used as a spray, glycerol could be added to the solution.

B. Physical Properties of the Solutions

As noted above in section I.A., the chemical makeup of the solutions can vary. This section compares solutions having differing chitosan and/or alcohol concentrations and the physical characteristics of these variations.

Solutions according to the present invention generally encompass two distinguishable classes of solutions; (1) sprayable solutions and (2) gels.

### 1. Sprayable Solutions

Sprayable solutions encompass low viscosity, generally having low mass fractions of chitosan with low molecular weight chitosan. Applications of these solutions would include direct application by swabbing, dabbing or spraying to traumatized tissue surfaces (such as burns, abrasions, perforations, cuts, lacerations) to reduce opportunistic infection and control minor bleeding. Application by swabbing, dabbing or spraying can be used to treat infections such as Staphylococcus vulgaris (acne), methicillin resistant Staphylococcus aureus (MRSA), Acinetobacter baumannii and other bacterial infections. As an example, regular swabbing of the nasal passages of hospital workers would assistant in the control of MRSA. Application by swabbing, dabbing, spraying can be used to eliminate biofilm colonies such as those of Staphylococcus epidermidis. The solutions may be used by way of spraying to deposit uniform, thin, antibacterial and antiviral films onto inanimate surfaces such as door handles, restaurant menus, clothing, medical gowns, medical face-covers, medical suite surfaces, or other objects where bacterial and viral inhibition is desired. Such films may also be sprayed directly onto a person's hands as a protective layer. Antiviral, antibacterial and hemostatic solutions may be applied easily, and cost-effectively, to medical dressings (e.g. the non-woven component of bandages), by a spray or drop-wise dispensing technique in a medical dressing manufacturing assembly process. Such applications are further demonstrated in section III.A. of the present application.

As discussed in the preparation of the solutions in section I.A, above, the amounts of chitosan and alcohol can vary. A low molecular weight chitosan is preferable so that the final solution has very high concentrations of chitosan, preferably having a concentration up to 10% w/w of chitosan material, with a relatively small amount of the chitosan material required to produce such a concentration. The amount of chitosan material could be increased, especially if a gel-type material is preferred, with chitosan concentrations being up to and above 25% w/w. For liquid solutions, however, the most preferred concentration is between 0.5%-2.0% w/w.

It has also been determined that lower concentrations of alcohol are preferable. While concentrations of isopropyl alcohol (IPA) have been formulated at 35% v/v and greater, lower concentrations are preferred because of the irritating and stinging effect of alcohol. However, the IPA is used to stabilize the viscosity of the final product. Furthermore, it helps in the coagulation process and in the antibacterial effects. Similar concentrations have been formulated using ethyl alcohol as those noted for IPA. These concentrations help provide stability of the solutions. As noted in Solution A in Table 1, above, the concentration was 25% v/v ethyl alcohol. While higher concentrations may be possible for ethyl alcohol, 25% v/v is preferred as an upper limit when using ethyl alcohol, because ethyl alcohol tends to form a precipitate at higher concentrations. However, it has been contemplated that alcohol concentrations between 2% and 35% v/v would be suitable for the present invention, with alcohol concentrations between 5% and 20% v/v being preferred.

As discussed above, the solutions formed in accordance with the present invention have the final pH adjusted by the use of an acid, with acetic, glycolic, hydrochloric, lactic, citric, and ascorbic acids being among the preferred acids. The pH of the final solutions are preferably within a range of 3.0-6.0, with the most preferred pH being around 4.5±0.5. Other compounds could be added to the solution, such as potassium chloride (KCl), sodium chloride (NaCl), calcium chloride (CaCl₂), sodium hydroxide (NaOH), and Witch Hazel, to provide further beneficial qualities to the final solution.

Table 2 demonstrates the stability of specific spray solutions over time, by monitoring viscosities of the solutions. The specific formulations were formed using isopropyl alcohol and were tested before and after 85 days of storage (from Dec. 18, 2003 until Mar. 12, 2004), being kept at room temperature (22° C.) under daylight conditions. The solutions also included a glycerol product (i.e. glycolate), which is used to enhance the plasticity of the solutions. Two solutions were tested with the following properties:

Solution M: 1% w/v chitosan, diluted in 0.7% v/v glycolate and 35% v/v isopropyl alcohol

Solution N: 1.5% w/v chitosan, diluted in 0.9% v/v glycolate and 35% v/v isopropyl alcohol

TABLE 2
Solution Viscosities After 85 days

| Solution | | Dec. 18, 2003 | Mar. 12, 2004 | % change |
|---|---|---|---|---|
| M | Viscosity | 40 | 48 | +17% |
| | cP | | | |
| | pH | 5.38 | 5.44 | +1.1% |
| N | Viscosity | 118 | 146 | +19% |
| | cP | | | |
| | pH | 5.12 | 5.32 | +3.7% |

As noted in Table 2, the viscosity has slightly decreased over the 85 day interval (The pH of each solution has also slightly increased but is considered to be an insignificant value increase). A possibility for the change in viscosity could be the loss of alcohol over time due to evaporation, which would increase the viscosity. Viscosity in a chitosan/alcohol solution will generally be lower than a chitosan solution without alcohol due to the hydrolytic scission of the chitosan molecule. However, it is believed that storage of the chitosan solution in a container that will prevent the evaporation of alcohol will lead to a consistent, stable viscosity of the solution, stable for two years or longer. The stability of the solutions of the present invention are discussed in further detail below.

### Stability

The stability of solutions developed according to the present invention were tested, specifically under forced degradation conditions. The study compares a chitosan solution with no alcohol to chitosan/alcohol mixtures with varied amounts of alcohol.

The study was conducted by preparing a 3.0% w/w chitosan gel solution, with chitosan material coming from Marinard Biotech, and having a degree of deacetylation of 95%. The samples were aliquotted into vials and diluted with ethanol (EtOH) and water for injection to reach the desired alcohol levels and 1.5% w/w chitosan in the solutions. The final volume (fv) of each of the samples was 2.0 ml. The solution conditions are shown below in Table 3. The samples were then placed in an oven at 50° C. for the specified times. After removal from the oven the samples were cooled to room temperature and then stored at 4° C. prior to molecular weight analysis.

TABLE 3
Solution Conditions

| | 3% Chitosan Gel | | | |
|---|---|---|---|---|
| Condition | (mL) | EtOH (mL) | Water (mL) | fv(mL) |
| 0% | 1 | 0 | 1 | 2 |
| 5% | 1 | 0.1 | 0.95 | 2 |
| 10% | 1 | 0.2 | 0.8 | 2 |
| 25% | 1 | 0.5 | 0.5 | 2 |
| 35% | 1 | 0.7 | 0.3 | 2 |

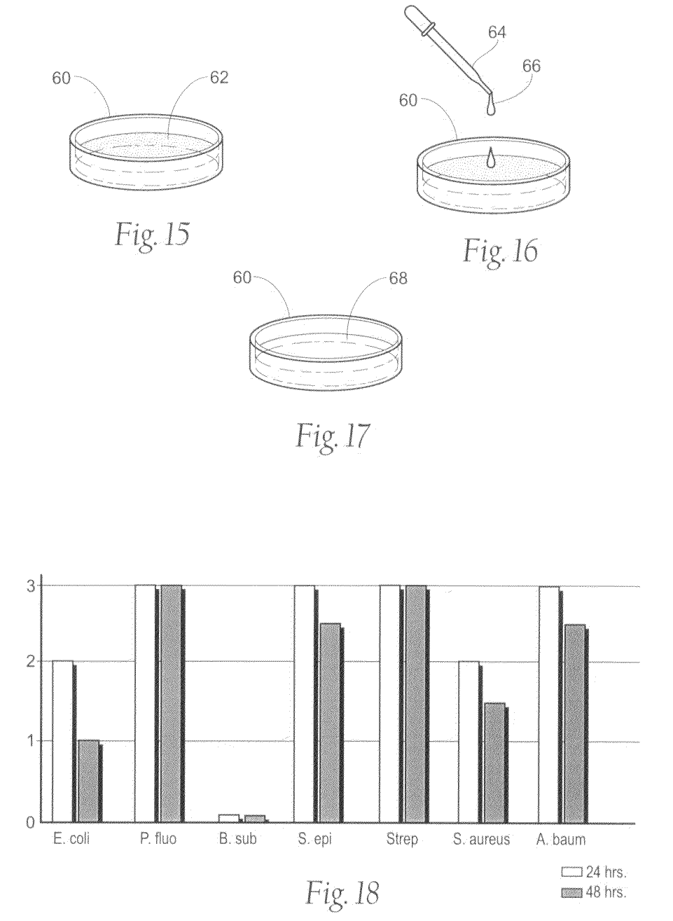

The molecular weight sample preparation included aliquotting samples into vials, compensating for the alcohol content to get equivalent chitosan concentration in each vial, as shown in Table 3. The samples were then dried (80° C.) to remove all water & alcohol and then dissolved in mobile phase solution. The sample solutions were analyzed for molecular weight in a size exclusion chromatography (SEC) system with Wyatt Dawn EOS multi-angle light scattering and Wyatt Optilab Rex refractive Index detectors. The various analysis times at which the samples were tested are shown in Table 4. The results are graphically represented in FIG. 15. Molecular weight testing demonstrated that the presence of alcohol stabilizes the chitosan solution by reducing random hydrolytic scissions in the chitosan polymer. In comparison, the 0% alcohol solutions showed poor stability as demonstrated by significant loss of molecular weight with time.

For example, the chitosan solution having no alcohol present, had an initial chitosan molecular weight of over 230,000 g/mol. After 30 days of test conditions, the same solution had a chitosan molecular weight of about 70,000 g/mol, showing significant degradation of the chitosan in the solution.

Conversely, the tested solution having 5% ethanol had an initial chitosan molecular weight of approximately 200,000 g/mol. After 30 days, the chitosan molecular weight was still about 190,000 g/mol. As indicated in FIG. 15, the other alcohol solution had similar results, with the solution significantly more stable than the solution that did not contain any alcohol. The results indicated that the solutions of the present invention are capable of maintaining the discussed therapeutic properties for extended periods of times with minimal loss in effectiveness.

TABLE 4
Stability Conditions Tested

| | 0% | 5% | | | |
|---|---|---|---|---|---|
| Condition | EtOH | EtOH | 10% EtOH | 25% EtOH | 35% EtOH |
| 30 minutes | √ | √ | √ | √ | √ |
| 1 hour | √ | √ | √ | ** | √ |
| 2 hour | √ | √ | √ | √ | √ |
| 4 hour | √ | √ | √ | √ | √ |
| 8 hour | √ | √ | √ | ** | √ |
| 24 hour | √ | √ | √ | √ | √ |
| 4 Day | √ | √ | √ | √ | √ |
| 5 Day | √ | √ | √ | ** | √ |
| 10 Day | √ | √ | √ | √ | √ |
| 15 Day | √ | √ | √ | ** | √ |
| 30 Day | √ | √ | √ | √ | √ |

** Samples excluded from data analysis due to loss of liquid during stability study.

### 2. Chitosan Gels

Compared to the sprays, gels generally comprise chitosan materials having higher mass fractions with possible high molecular weight or partially being ionically crosslinked {i.e. use of bifunctional or higher functional acids}. A thick lip-balm type form of the composition is possible by use of partial crosslinking and increased chitosan mass fraction. Such a lip-balm form of a chitosan solution in a screw type dispenser would be amenable to application to control minor bleeding in shaving cuts and reduce possible infection. Such gels are formed and stored in such a manner so that evaporation of alcohol form the solutions is minimized. Applications of such solutions are demonstrated in section III.B. of the present application.

The chitosan gel solutions are more viscous than the spray solutions, as demonstrated in Table 5. The concentration of chitosan materials used in the gel solutions typically are higher than those used in liquid solutions according to the present invention, with concentrations possibly being at 25% w/v or greater. As noted above, the significant reduction in viscosity on chitosan solutions without alcohol at room temperature is caused by the hydrolytic scission of the chitosan molecules.

TABLE 5
Chitosan Gel Viscosities

| | UltraPure CN | | UltraPure CN | | Pure CN | | Production CN | |
|---|---|---|---|---|---|---|---|---|
| | 20692 | | 20371 | | 20694 | | 20003 | |
| Day | RT | 2-8° C. | RT | 2-8° C. | RT | 2-8° C. | RT | 2-8° C. |
| | Gel Type (Viscosity (cP)) (Tested at 5 rpm) | | | | | | | |
| 0 | 3917 | 3917 | 6906 | 6906 | 5267 | 5267 | 1980 | 1980 |
| 1 | 4265 | 4463 | 6839 | 6696 | 5067 | 5147 | 1788 | 2058 |
| 2 | 4079 | 4403 | 6524 | 6831 | 5105 | 5387 | 1455 | 2004 |
| 3 | no data | no data | no data | no data | no data | no data | no data | no data |
| 4 | no data | no data | no data | no data | no data | no data | no data | no data |
| 5 | no data | no data | no data | no data | no data | no data | no data | no data |
| 6 | 3389 | 4373 | 5741 | 6824 | 4529 | 5447 | 991 | 1914 |
| 7 | 3329 | 4235 | 5627 | 6804 | 4451 | 5273 | 1080 | 1944 |
| 8 | 3262 | 4283 | 5687 | 6411 | 4373 | 5117 | 900 | 1848 |
| % | 16.7% | −9.3% | 17.7% | 7.2% | 17.0% | 2.8% | 54.5% | 6.7% |
| loss | | | | | | | | |
| at | | | | | | | | |
| day 8 | | | | | | | | |
| | Gel Type (Viscosity Tested at Optimal rpm) | | | | | | | |
| 0 | 3789 | 3789 | 6906 | 6906 | 5267 | 5267 | 1802 | 1802 |
| 1 | 4059 | 4389 | 6839 | 6696 | 4999 | 5147 | 1665 | 1860 |
| 2 | 3989 | 4324 | 6524 | 6831 | 5029 | 5387 | 1273 | 1830 |
| 3 | no data | no data | no data | no data | no data | no data | no data | no data |
| 4 | no data | no data | no data | no data | no data | no data | no data | no data |
| 5 | no data | no data | no data | no data | no data | no data | no data | no data |
| 6 | 3389 | 4304 | 5741 | 6824 | 4529 | 5447 | 991 | 1790 |
| 7 | 3299 | 4169 | 5627 | 6804 | 4414 | 5273 | 983 | 1775 |
| 8 | 3249 | 4214 | 5687 | 6411 | 4304 | 5024 | 848 | 1742 |
| % | 14.3% | −11.2% | 17.7% | 7.2% | 18.3% | 4.6% | 52.9% | 3.3% |
| loss | | | | | | | | |
| at | | | | | | | | |
| day 8 | | | | | | | | |

The gels in Table 5 were prepared in ˜30 ml aliquots, using 50 ml Falcon Tubes, and stored at either 2-8° C. or at room temperature. At each time interval for each condition, a separately prepared sample, approximately ˜15 ml aliquot, using a 50 ml Falcon tube, was frozen at −60° C. for later testing to determine whether there was any change in molecular weight during the testing. Between 10-11 ml of each sample was tested using a Brookfield Viscometer using a small adapter kit spindle. Sample conditions were tested at 25° C. at both 5 revolutions per minute (rpm) and the optimal torque rpm. The majority of the sample conditions were frozen after testing (separate from the GPC samples), with the final sample kept at its conditions (2-8° C. or RT) for testing at a later date.

To provide for high viscosity aqueous gel forms of chitosan solutions the fraction of chitosan could likely be increased to near 25%, the use of ionic cross-linking of the chitosan with acids (multifunctional acid use such as citric acid, malic acid, malonic acid, adipic acid, succinic acid, polyphosphoric acid) and alcohols such as glycerol, butanol, sec-butanol, isobutanol, erythritol, arabitol, xylitol, or sorbitol could be used in combination with either ethyl alcohol or isopropyl alcohol.

### II. Analysis of the Properties and Qualities of the Solution

The solutions according to the present invention have various beneficial antiviral, antibacterial and hemostatic properties. The following section discusses the effects of these solutions and the overall properties of the solutions according to the present invention as follows:

A. Analysis of the Solutions on Biofilms—This section demonstrates testing of the chitosan solutions and their effects on bacteria and microbes formed on biofilms.

B. Analysis of the Solutions on Combating Bacteria and Microbes—This section demonstrates further testing of the chitosan solutions on various, specific bacteria.

C. Hemostatic Properties of the Solutions—This section compares chitosan solutions having differing molecular weights, chitosan concentrations, and alcohol concentrations of the solutions.

D. Conclusion

A. Analysis of the Solutions on Biofilms Chitosan/alcohol solutions developed according to the present invention were tested for their efficacy in treating biofilms. Specifically, the solutions were tested to determine efficacy in inhibition of biofilm accumulation and killing of bacteria in pre-accumulated biofilms.

Adhesion to surfaces is a common and well-known behavior of micro-organisms in many habitats, specifically habitats where water or other fluids may be present. This adhesion and the subsequent microbial growth lead to the formation of biofilms. Bacterial biofilms promote increased biomass deposition, resulting in surfaces and environments that are less than desirous regarding sterility and cleanliness, and can lead to increased risks of viral infections.

Treatment of biofilms arises in many different environments and on many differing environments, including treatment of water supplies, treatment of medical and dental equipment, treatment during medical and dental procedures, and general cleaning and disinfecting of a wide range of surfaces. Even though there is a wide range of areas for which treatment may be necessary or desirous, there are also some common factors to take into account. Treatment compounds and solutions must not be too toxic for their use, especially when being on and around humans.

FIGS. 15-17 depict a general procedure for testing efficacy of the solutions of the present invention. FIG. 15 shows a Petri dish 60 containing a biofilm 62, specifically an S. epidermidis biofilm, that was grown in the Petri dish 60 overnight. The biofilm 62 was subjected to a chitosan/alcohol solution 66 for one (1) hour, with the solution 66 being delivered by any delivery means 64 as is commonly used and understood in the art. As an example, the solution 66 had the properties of solution A, in Table 1, above. That is, the solution consisted of 1.5% w/v chitosan (75 ppm chitosan) having a molecular weight of 150-300 kDa and a deacetylation of 95%. The solution 66 also contained 25% v/v ethyl alcohol. After treatment for one (1) hour, the biofilm 62 was tested and counted according to common standards in the art, with 100% of the bacteria in the biofilm 62 being killed. This complete effectiveness is represented by a “clear” biofilm 68 in FIG. 17, indicating that the solution 66 provided sufficient antibacterial effects.

The experiment carried out in FIGS. 15-17 can be carried out to test against other microbes and bacteria, again using standard practices in the industry. Section B, below, provides further data and analysis of the efficacy of the chitosan/alcohol solutions against other bacteria.

B. Analysis of the Solution on Combating Bacteria and Other Microbes

FIG. 18 presents a graphical representation of various bacteria being treated with a chitosan/alcohol solution of the present invention, consistent with the solution that was used and described in section II.A. The bacteria were treated and evaluated after 24 and 48 hours to determine the activity of the chitosan/alcohol solution on each of the bacteria. The graph in FIG. 18 uses a scale of 0-3 to demonstrate the activity of the solution in combating each of the various bacteria, with 0 relating to no activity or negative activity, and 3 demonstrating a very high level of activity. That is, the table refers to the solutions' ability to interfere with bacterial replication within a planktonic culture. The results from Table 3 are stated as follows:

(E. coli) Escherichia coli (Gram negative; model for enteropathogenic O157:H7, ETEC, EIEC, EPEC): Slightly active after 24 hours, with diminished activity after 48 hours.

(P. fluo) Pseudomonas fluorescens (Gram Negative; model for P. aeruginosa): Very active after both 24 and 48 hours

(B. sub) Bacillus subtilis (Gram positive; spore and biofilm-forming model for B. anthracis and B. cereus): The solution was inactive against this bacterium

(S. epi) Staphylococcus epidermidis (Gram positive; model for S. aureus and S. saprophiticus): The solution was considerably active at 24 hours, with a slight loss in activity at 48 hours.

(Strep) Group A Streptococcus (Gram positive; GAS, Streptococcus pyogenes): Very Active after both 24 and 48 hours

(S. aureus) Methicillin-resistant Staphylococcus aureus (Gram Positive): Moderately active after 24 hours, with diminished activity after 48 hours.

(A. baum) Acinetobacter baumannii (Gram negative): Very active after 24 hrs, with some loss of activity after 48 hours.

The testing produced other significant results for the chitosan/alcohol solutions as follows:

Toxicity—The toxicity of the solution was tested to determine the solutions toxicity on mammalian cells. standard MTT toxicity assays were performed on HeLa cells. The IC₅₀ (50% killing of HeLa cells) for the chitosan/alcohol solution was found to be ˜375 ppm. Compared to chlorhexidine gluconate, the solution is approximately 100-fold less toxic, which indicates that the solutions are capable of being used on humans.
Concentration—Concentration-Dependence of the chitosan/alcohol solutions' antibacterial activity on planktonic cells. The solutions were further tested to compare levels of effectiveness compared to the concentration of the material within the solutions. 7500 ppm chitosan material within the solution kills greater than 99% (>99%) of E. coli, B. sub, S. epi & B. sub within one hour, with killing being established by subsequent colony plate counts.

1500 ppm chitosan material within the solution kills >99% of the E. coli, S. epi & P. fluo model bacteria within one hour, but not B. sub.

750 ppm chitosan material within the solution kills >99% of the E. coli, S. epi & P. fluo model bacteria within one hour, but only ˜40% B. sub.

750 ppm chitosan material within the solution kills >99% of the Group A. Strep & A. baumannii human pathogens within one hour, but only ˜70% of S. aureus.

The minimal inhibitor concentrations (MIC) for all species were lower than 750 ppm chitosan material.

Decreasing bacteria in a pre-formed biofilm—100% of the bacteria within S. epidermidis pre-formed biofilm are killed with one hour exposure to 7500 ppm of the chitosan/alcohol solution.

Greater than 99% (>99%) of bacteria in the naturally occurring (i.e. produced water) pre-formed biofilms are killed with one hour exposure to 3000 ppm of the chitosan/alcohol solution.

100% of bacteria in the naturally occurring (produced water) pre-formed biofilms are killed with one hour exposure to 7500 ppm of the chitosan/alcohol solution.

Effects with other compounds—The chitosan/alcohol solutions were tested in combination with other compounds to determine synergistic effects of the combinations. That is, the chitosan alcohol was combined with other compounds known to have therapeutic or antiviral characteristics.

Combination with Ethylenediamine Tetraacetic Acid (EDTA)

Chitosan/alcohol solutions (75 & 100 ppm) show synergy with EDTA (10 mM) for E. coli

Chitosan/alcohol solution (75 ppm) shows synergy with EDTA (0.1 mM) for P. fluo.

No synergy is shown for S. epi, S. aureus & Strep A.

Chitosan/alcohol solution (75 ppm) shows synergy with EDTA (0.1 mM) for A. baumannii (particularly upon longer term exposure)

### Antibiotics

No apparent difference in sensitivity of the multi-drug resistant strain of S. aureus to the chitosan/alcohol solutions compared to the drug-sensitive strain

Synergy possible for S. aureus BAA-44 (the drug-resistant strain) between chitosan/alcohol solutions and Tetracycline

No other synergy identified

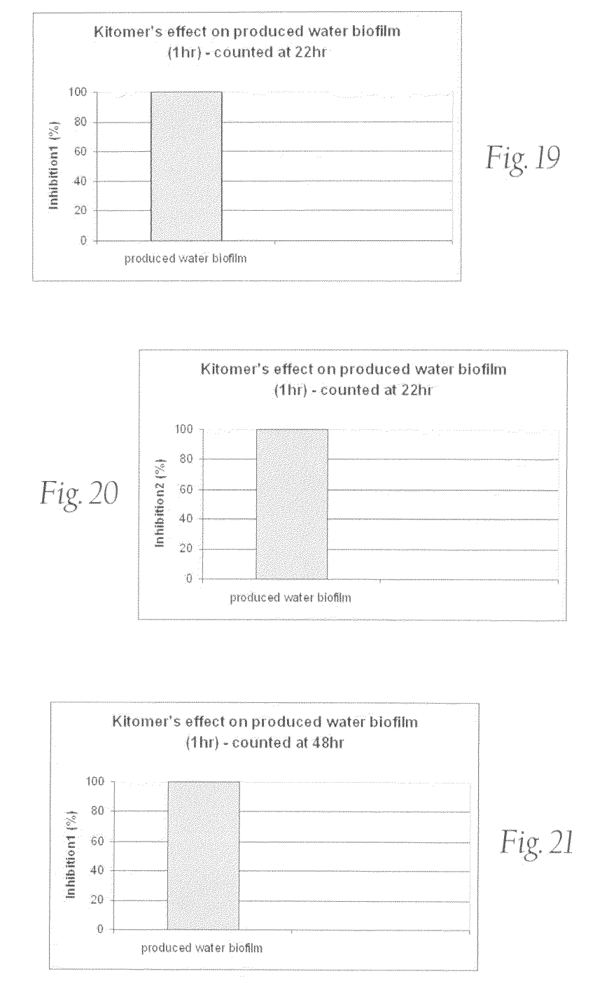

Thus, the indications are that the chitosan/alcohol solutions are efficient materials at combating various produced water biofilm and various bacterial and viral infections. FIGS. 19-26 further demonstrate the efficacy of the chitosan/alcohol solutions as compared against various biofilms. The tested chitosan/alcohol solution consisted of 1.5% w/v chitosan having a molecular weight of 150-300 kDa and a deacetylation of 95% (75 ppm chitosan). The solution also contained 25% v/v ethyl alcohol. The solution was tested using two different representative formulas:

Inhibition1(%)=[1-(CFUwithKitomer)/(CFUwithoutKitomer)]*100

Inhibition2(%)=[1-(logCFUwithKitomer)/(logCFUcontrol)]*100

FIG. 19 (Inhibition1) and FIG. 20 (Inhibition2) tested the effects of chitosan/alcohol solution on a produced water biofilm, with the biofilm being subjected to the chitosan/alcohol solution for 1 (one) hour. The bacterial inhibition was counted after 22 hours. Both results indicated 100% inhibition.

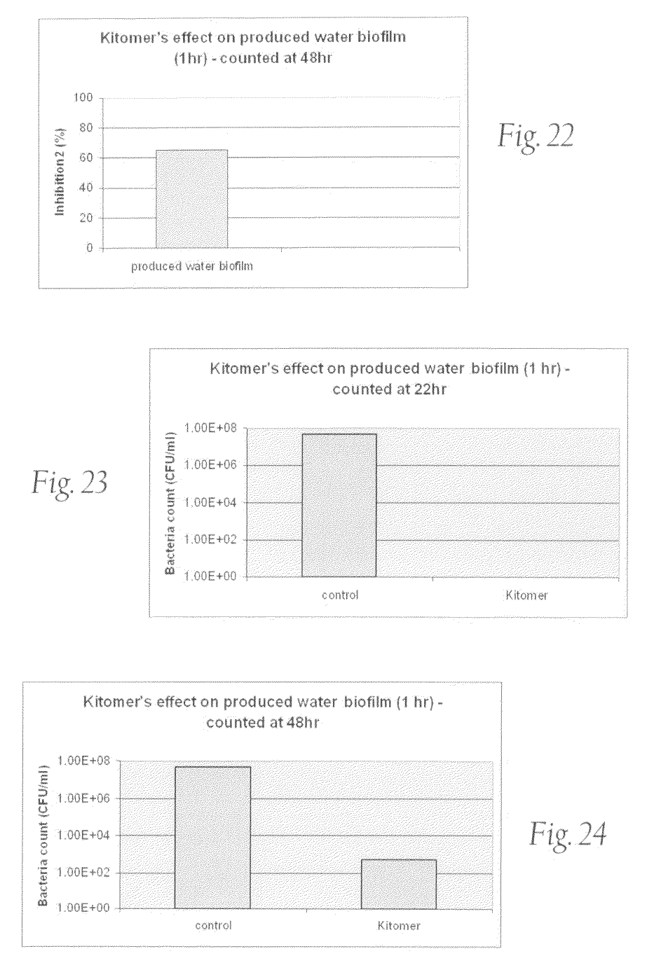

FIG. 21 (Inhibition1) and FIG. 22 (Inhibition2) tested the effects of chitosan/alcohol solution on a produced water biofilm, with the biofilm being subjected to the chitosan/alcohol solution for 1 (one) hour. The bacterial inhibition was counted after 48 hours. The inhibition of FIG. 21 indicates 100% inhibition, while the inhibition according to FIG. 22 indicates about 67% inhibition.

FIG. 23 depicts the effects of chitosan/alcohol solution on a produced water biofilm, with the biofilm being subjected to the chitosan/alcohol solution for 1 (one) hour. The chitosan/alcohol solution was tested against a control solution. The bacteria present (in CFU/ml) were counted after 22 hours, with the chitosan/alcohol solution showing no bacteria present and the control showing 1.00E+08 bacteria present.

FIG. 24 depicts the effects of chitosan/alcohol solution on a produced water biofilm, with the biofilm being subjected to the chitosan/alcohol solution for 1 (one) hour. The chitosan/alcohol solution was tested against a control solution. The bacteria present (in CFU/ml) were counted after 48 hours, with the control showing 1.00E+08 bacteria present and the chitosan/alcohol solution showing approximately 1.00E+03 bacteria present.

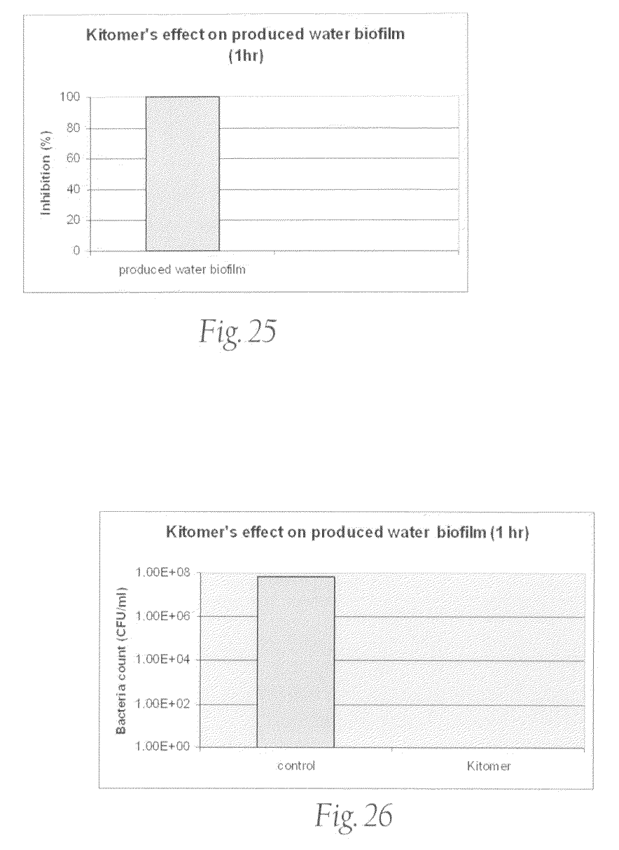

FIG. 25 presents the effects of chitosan/alcohol solution on a produced water biofilm, with the biofilm being subjected to the chitosan/alcohol solution for 1 (one) hour. The results indicated 100% inhibition.

FIG. 26 depicts the effects of chitosan/alcohol solution on a produced water biofilm, with the biofilm being subjected to the chitosan/alcohol solution for 1 (one) hour. The chitosan/alcohol solution was tested against a control solution. The bacteria present (in CFU/ml) were counted, with the chitosan/alcohol solution showing no bacteria present and the control showing 1.00E+08 bacteria present.

FIGS. 27A-27C further demonstrate the efficacy of the solutions according to the present invention. Solutions having various concentrations, from 0 parts per million (ppm) to 552 ppm were tested for their efficiency in killing the pathogen Pseudomonas aeruginosa (P. aer.) to determine the minimal concentrations needed to effectively kill 100% of the P. aer. bacteria. FIG. 27A provides a control test where none of the bacteria were present during the test. Bacteria were present in the testing reported in FIGS. 27B and 27C, and testing was recorded overnight, with FIG. 27B showing data recorded for 23 hours and FIG. 27C showing data recorded for 25 hours. The results were similar in the tests of FIGS. 27B and 27C, with a concentration of 64 ppm and greater capable of killing 100% of the bacteria P. aer. These results are impressive, as they demonstrate that solutions of the present invention can have very low levels of chitosan material, while still being efficient. The results are also indicative that solutions formed in accordance with the present invention could be effective in killing other bacteria, such as S. aureus and possibly methicillin-resistant Staphylococcus aureus (commonly referred to as MRSA).

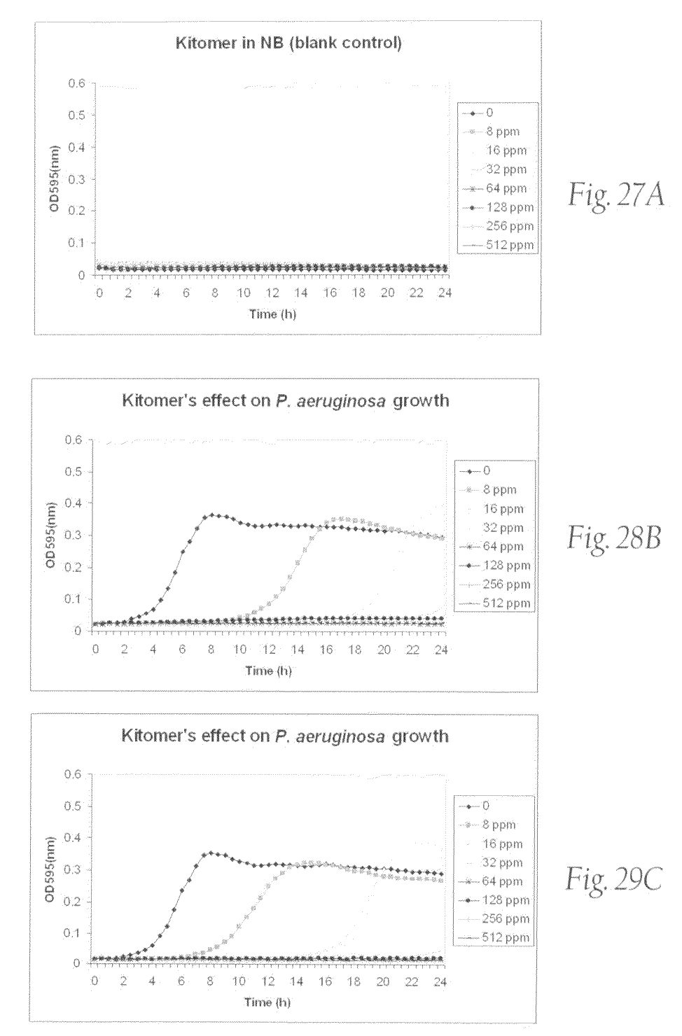

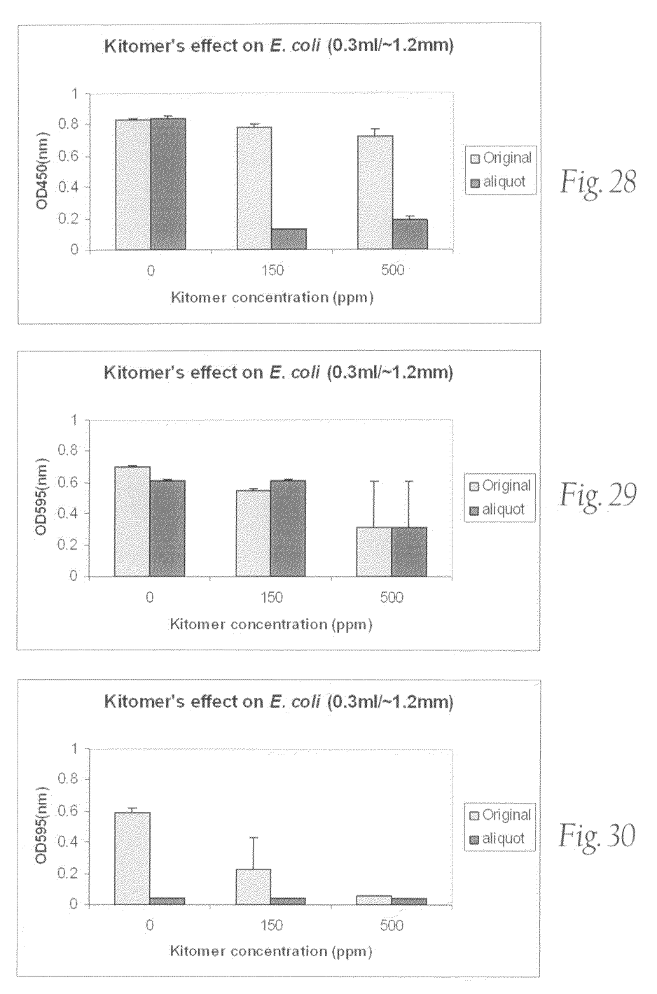

FIGS. 28-30 depict the efficacy of solutions prepared according to the present invention on killing Escheria Coli ATCC 25922 (E. Coli). Solutions were formulated, according to the present invention, having various amounts of chitosan material within the solutions. The efficacy was tested at various time intervals. Testing was carried out by pipetting 10 μl samples of a fresh E. Coli culture overnight onto a 24-well plate. Each of the bacteria solutions was then covered by 0.3 ml of chitosan solution having varying concentrations of chitosan material within the solution. The solutions were left to sit underneath a sterile hood until dry. After 12 and 24 hours, an additional 1 ml of each of the chitosan solutions was added to each well-plate. 20 μl of each solution was then siphoned from each well and placed onto a second well-plate containing a fresh 1 ml E. Coli solution. The second well-plate was then incubated at 37° C. for 48±2 hours and the OD595 nm measurements were taken. For comparison, aliquot samples of each solution concentration, 200 μl each placed upon 96-well plates, and the OD595 nm measurements were taken.

FIG. 28 shows the chitosan solutions' effect on E. Coli after being left under a sterile hood for twelve (12) hours and allowed to dry. The solutions had an approximate thickness of 1.2 ml. Three concentrations of chitosan, 0 ppm (i.e. pure H₂O), 150 ppm, and 500 ppm, were tested and recorded. The solutions having 150 ppm and 500 ppm slightly inhibited growth of the bacteria, but did not completely kill the bacteria.

FIG. 29 shows the chitosan solutions, as described in FIG. 28, on E. Coli after being allowed to dry for eighteen (18) hours. The solutions having 150 ppm and 500 ppm inhibited the growth of the bacteria better than that shown in FIG. 28, but did not completely kill the bacteria, either.

FIG. 30 shows the chitosan solutions, as described in FIG. 28, on E. Coli after being allowed to dry for twenty-four (24) hours. The solution having 150 ppm of chitosan significantly inhibited the growth of the bacteria but did not completely kill the bacteria. The solution having 500 ppm chitosan was able to completely kill the E. Coli.

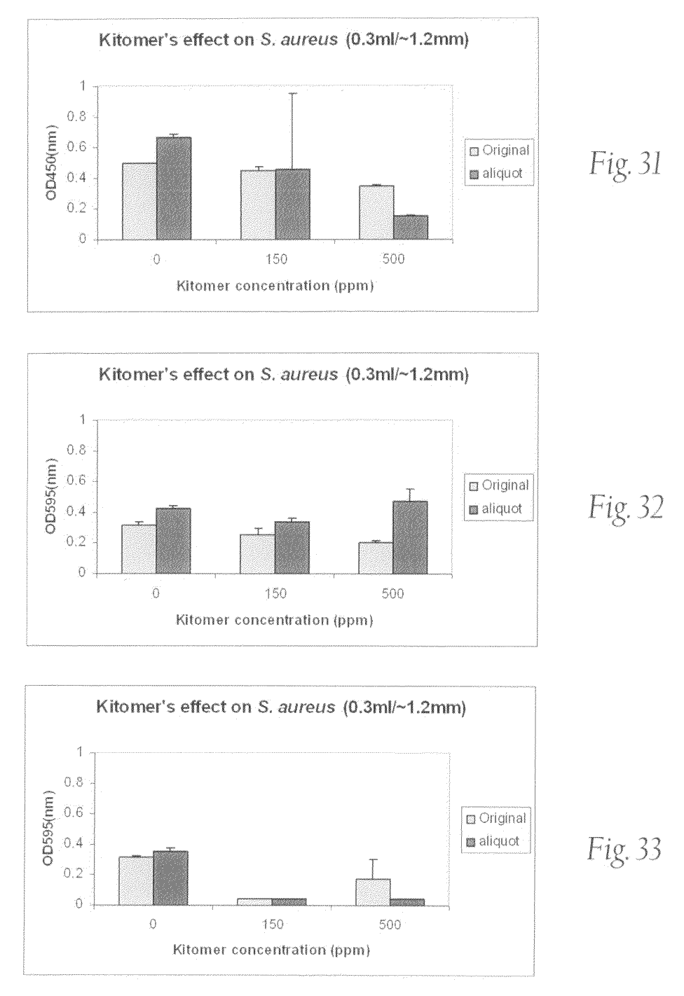

FIGS. 31-33 depict the efficacy of solutions prepared according to the present invention on killing Staphylococcus aureus ATCC BAA-44 (S. aureus). Solutions were formulated, according to the present invention, having various amounts of chitosan material within the solutions. The efficacy was tested at various time intervals. Testing was carried out by pipetting 10 μl samples of a fresh S. aureus culture overnight onto a 24-well plate. Each of the bacteria solutions was then covered by 0.3 ml of chitosan solution having varying concentrations of chitosan material within the solution. The solutions were left to sit underneath a sterile hood until dry. After 12 and 24 hours, an additional 1 ml of each of the chitosan solutions was added to each well-plate. 20 μl of each solution was then siphoned from each well and placed onto a second well-plate containing a fresh 1 ml S. aureus solution. The second well-plate was then incubated at 37° C. for 48±2 hours and the OD595 nm measurements were taken. For comparison, aliquot samples of each solution concentration, 200 μl each placed upon 96-well plates, and the OD595 nm measurements were taken.

FIG. 31 shows the chitosan solutions' effect on S. aureus after being left under a sterile hood for twelve (12) hours and allowed to dry. The solutions had an approximate thickness of 1.2 ml. Three concentrations of chitosan, 0 ppm (i.e. pure H₂O), 150 ppm, and 500 ppm, were tested and recorded. The solutions having 150 ppm and 500 ppm slightly inhibited growth of the bacteria, but did not completely kill the bacteria.

FIG. 32 shows the chitosan solutions, as described in FIG. 31, on S. aureus after being allowed to dry for eighteen (18) hours. The solutions having 150 ppm and 500 ppm inhibited the growth of the bacteria better than that shown in FIG. 31, but did not completely kill the bacteria, either.

FIG. 33 shows the chitosan solutions, as described in FIG. 31, on S. aureus after being allowed to dry for twenty-four (24) hours. The solutions having 150 ppm and 500 ppm chitosan were able to completely kill the S. aureus.

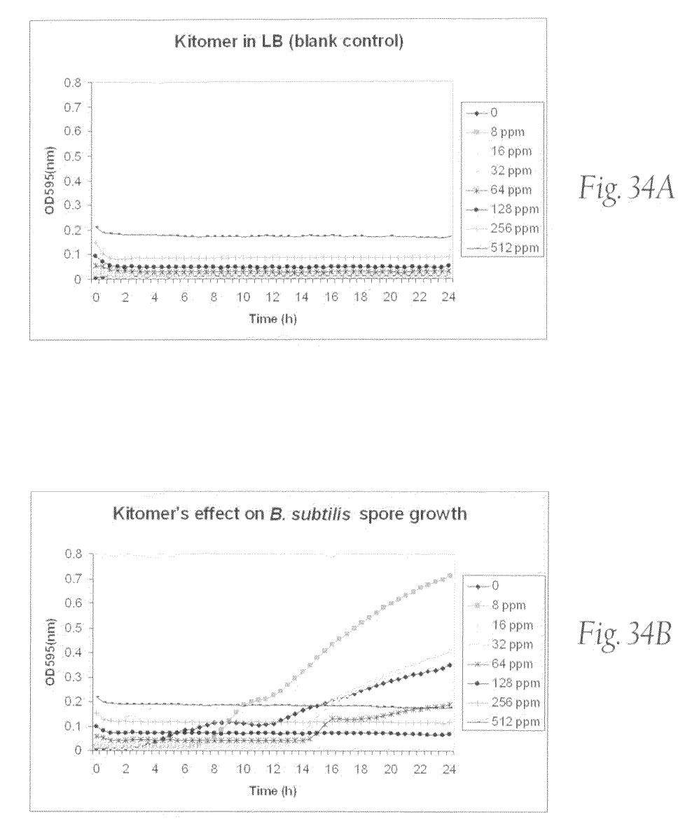

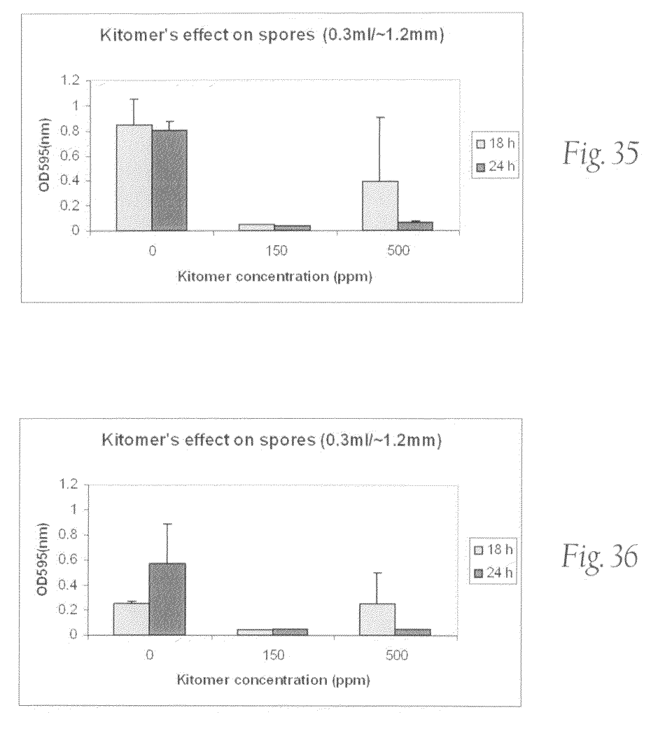

The solutions of the present invention were also tested to determine efficacy in inhibiting spore growth and killing bacteria spores, specifically Bacillus subtilis (B. sub.) spores having a concentration of approximately 10⁷ spores/ml. FIG. 34A and FIG. 34B demonstrate the efficacy of chitosan solutions of various concentrations in controlling B. sub. spore growth. FIGS. 35 and 36 depict the efficacy of the chitosan solutions in killing B. sub. spores.

FIGS. 34A and 34B graphically show chitosan solutions formulated according to the present invention and having various chitosan concentrations, 0 ppm, 8 ppm, 16 ppm, 32 ppm, 64 ppm, 128 ppm, 256 ppm, and 512 ppm. 2 μl samples of B. sub. spores, having an approximate concentration of 2×10⁴ spores/ml were grown in the presence of the chitosan solutions of the noted concentrations. The spores were grown for 24 hours in a 96-well plate, using a 2-fold dilution method. The OD595 nm values for each concentration were monitored using a 96-well plate reader and were recorded.

FIG. 34A graphically depicts the absence of change of spore growth of B. Subtilis over 24 hours in solutions having various amounts of chitosan material within the solution, developed according to the present invention, on a no spore blank control. The OD595 measurements were consistent over the 24 hour period.

FIG. 34B graphically depicts a correlation in spore growth of B. sub. inhibition with chitosan concentration of the solutions shown in FIG. 34A on the spore growth of B. sub. over 24 hours of contact with the spore. After eight (8) hours of contact with the B. sub., the chitosan concentrations at 16 ppm and greater were effective in controlling spore growth. After twelve (12) hours of contact, the chitosan concentrations at 16 ppm or greater were still effective at controlling spore growth. Over the full twenty-four (24) hour period, chitosan concentrations at 128 ppm and greater were still effective at controlling spore growth.

FIGS. 35-36 depict the efficacy of solutions prepared according to the present invention on killing B. Sub. spore growth. Solutions were formulated, according to the present invention, having various amounts of chitosan material within the solutions. The efficacy was tested at various time intervals. Testing was carried out by pipetting 10 μl samples of a fresh B. sub. culture overnight onto a 24-well plate. Each of the bacteria solutions was then covered by 0.3 ml of chitosan solution having varying concentrations of chitosan material within the solution. The solutions were left to sit underneath a sterile hood until dry. After 18 and 24 hours, an additional 1 ml of each of the chitosan solutions was added to each well-plate and the well-plates were incubated at 37° C. After approximately 42-48 hours, 20 μl of each solution was then siphoned from each well and placed onto a second well-plate containing a fresh 1 ml B. sub. solution. The second well-plate was then incubated at 37° C. for approximately 60-70 hours and the OD595 nm measurements were taken. For comparison, aliquot samples of each solution concentration; 200 μl each placed upon 96-well plates, and the OD595 nm measurements were taken.

FIG. 35 shows the results of the original samples and FIG. 36 shows the results of the 20 μl samples after they had been incubated for at least 42 hours. After up to 70 total hours of incubation, there was no spore growth for both chitosan concentrations of 150 ppm and 500 ppm that had been originally dried with the spores for 24 hours. After up to 48 total hours of incubation, there was no spore growth for both chitosan concentrations of 150 ppm and 500 ppm that had been originally dried with the spores for 18 hours. After up to 70 total hours of incubation, there was no spore growth for the chitosan concentration of 150 ppm that had been originally dried with the spores for 18 hours. However, after up to 70 total hours of incubation, one of the samples having a chitosan concentration of 500 ppm that had been originally dried with the spores for 18 hours.

As demonstrated with the above data, the chitosan/alcohol solutions of the present invention show significant inhibition against various bacteria, which indicates that the solutions provide good anti-bacterial protection. Section C, below, further describes the qualities of the chitosan/alcohol solutions, specifically discussing the hemostatic qualities of the solution.

C. Hemostatic Properties of the Solutions

Various chitosan/alcohol solutions developed according to the present invention were tested for hemostatic properties. Five different classifications of chitosan were used in the solutions as follows:

HV: High molecular weight (>1000 kDa), low deacetylation (75-85%)
MV1: Medium Mw (500-1000 kDa), low deacetylation (75-85%)
MV2: Medium Mw (500-1000 kDa), high deacetylation (>95%)
LV1: Low Mw (50-100 kDa), low deacetylation (75-85%)
LV2: Low Mw (50-100 kDa), high deacetylation (>95%)

The chitosan concentrations were either 1 or 2% w/w concentration. The alcohols used were either isopropyl alcohol (IPA) or ethyl alcohol (EtOH), with the concentrations being between 10-35% V/V. The solutions were made using acids to adjust the pH to between 4.5 and 5.0, as discussed in section I.A. and demonstrated in FIG. 5. In the present examples, the acids used were either lactic or acetic acid, with both acids being at 1% v/v. Sodium Chloride (NaCl) at 3 mM and calcium chloride (CaCl₂) 3 mM were used as additional additives in various samples. The samples were used to test and assess the effect on coagulation time of the various solutions on human whole blood. The results are listed below in Table 6-Table 10.

TABLE 6
Subject: SSP
First Sample blood test trial: 100 ml

| VIALS# | Chito/conc | Acid | Alcohol | Additives | Time |
|---|---|---|---|---|---|
| 1 | — | — | — | — | 23 m 30 s |
| (ctrl) | | | | | |
| 2 | HV@1% | Acetic | — | — | 18 m 30 s |
| 3 | HV@1% | Lactic | — | — | 17 m 30 s |
| 4 | MV1@2% | Acetic | — | — | 17 m 30 s |
| 5 | MV1@2% | Lactic | — | — | 17 m 00 s |
| 6 | MV2@2% | Acetic | — | — | 11 m 30 s |
| 7 | MV2@2% | Lactic | — | — | 9 m 30 s |
| 8 | LV1@2% | Acetic | — | — | 15 m 30 s |
| 9 | LV1@2% | Lactic | — | — | 14 m 00 s |
| 10 | LV2@2% | Acetic | — | — | 9 m 30 s |
| 11 | LV2@2% | Lactic | — | — | 8 m 00 s |

TABLE 7
Subject: SSP
Second Sample blood test trial: 100 ml

| VIALS# | Chito/conc | Acid | Alcohol | Additives | Time |
|---|---|---|---|---|---|
| 1 | MV2@2% | Lactic | IPA@35% | — | 3 m 30 s |
| 2 | MV2@2% | Lactic | IPA@10% | — | 8 m 30 s |
| 3 | MV2@2% | Lactic | EtOH@35% | — | 7 m 30 s |
| 4 | MV2@2% | Lactic | EtOH@10% | — | 6 m 00 s |
| 5 | LV2@2% | Lactic | IPA@35% | — | 2 m 30 s |
| 6 | LV2@2% | Lactic | IPA@10% | — | 4 m 30 s |
| 7 | LV2@2% | Lactic | EtOH@35% | — | 4 m 30 s |
| 8 | LV2@2% | Lactic | EtOH@10% | — | 5 m 30 s |
| 9 | LV2@1% | Lactic | IPA@35% | — | 10 m 30 s |
| 10 | LV2@1% | Lactic | IPA@10% | — | 12 m 30 s |
| 11 | LV2@1% | Lactic | EtOH@35% | — | 4 m 30 s |
| 12 | LV2@1% | Lactic | EtOH@10% | — | 5 m 30 s |

TABLE 8
Subject: NB (EXACTLY THE SAME CONDITIONS AS
SUBJECT SSP)
First Sample blood test trial: 100 ml

| VIALS# | Chito/conc | Acid | Alcohol | Additives | Time |
|---|---|---|---|---|---|
| 1 | — | — | — | — | >20 m |
| (ctrl) | | | | | |
| 2 | HV@1% | Acetic | — | — | >20 m |
| 3 | HV@1% | Lactic | — | — | >20 m |
| 4 | MV1@2% | Acetic | — | — | 18 m 00 s |
| 5 | MV1@2% | Lactic | — | — | >20 m |
| 6 | MV2@2% | Acetic | — | — | 10 m 00 s |
| 7 | MV2@2% | Lactic | — | — | 9 m 00 s |
| 8 | LV1@2% | Acetic | — | — | 18 m 30 s |
| 9 | LV1@2% | Lactic | — | — | 15 m 00 s |
| 10 | LV2@2% | Acetic | — | — | 9 m 00 s |
| 11 | LV2@2% | Lactic | — | — | 8 m 00 s |

TABLE 9
Subject: NB (EXACTLY THE SAME CONDITIONS AS
SUBJECT SSP)
Second Sample blood test trial: 100 ml

| VIALS# | Chito/conc | Acid | Alcohol | Additives | Time |
|---|---|---|---|---|---|
| 1 | MV2@2% | Lactic | IPA@35% | — | 4 m 00 s |
| 2 | MV2@2% | Lactic | IPA@10% | — | 2 m 30 s |
| 3 | MV2@2% | Lactic | EtOH@35% | — | 8 m 30 s |
| 4 | MV2@2% | Lactic | EtOH@10% | — | 6 m 00 s |
| 5 | LV2@2% | Lactic | IPA@35% | — | 3 m 00 s |
| 6 | LV2@2% | Lactic | IPA@10% | — | 4 m 30 s |
| 7 | LV2@2% | Lactic | EtOH@35% | — | 2 m 30 s |
| 8 | LV2@2% | Lactic | EtOH@10% | — | 5 m 30 s |
| 9 | LV2@1% | Lactic | IPA@35% | — | 12 m 30 s |
| 10 | LV2@1% | Lactic | IPA@10% | — | 15 m 00 s |
| 11 | LV2@1% | Lactic | EtOH@35% | — | 5 m 30 s |
| 12 | LV2@1% | Lactic | EtOH@10% | — | 5 m 30 s |

TABLE 10
SUBJECT: CB: WITH OTHER ADDITIVES
Sample blood test trial: 100 ml

| VIALS# | Chito/conc | Acid | Alcohol | Additives | Time |
|---|---|---|---|---|---|
| CTRL | — | — | — | — | >20 m |
| 2 | LV2@2% | Lactic | IPA@35% | 3 uM Ca | >20 m |
| 3 | LV2@2% | Lactic | IPA@35% | 3 mM Ca | >20 m |
| 4 | LV2@2% | Lactic | IPA@35% | 3 uM Cl | >20 m |
| 5 | LV2@2% | Lactic | IPA@35% | 3 mM Cl | >20 m |
| 6 | LV2@2% | Lactic | IPA@35% | — | 2 m 30 s |

As demonstrated by Table 6-10, the control, which was only blood to a compensated volume of liquid, shows coagulation after 20 minutes. However, the solutions of the present invention had better coagulation times, with the best formulation providing coagulation within 3 minutes. It was further determined that the formed blood clot using the solutions of the present invention were firmer than the blood clot formed by the control. It also has been determined that the degree of deacetylation is a key parameter for coagulation. A 99% deacetylated chitosan with a low molecular weight (20 cps standard solution viscosity) was used. However, it appears that the molecular weight has no influence on the coagulation time. Different additives at different concentrations of Cl₂, Ca²⁺, and with different acids and alcohols were tested, as well. The results indicate that lactic acid at a pH of 4-5, without any additives, and a final concentration of 35% of IPA, provides good coagulation. With all of the samples, it appears that better coagulation will be present with higher chitosan concentrations.

D. Conclusion

Chitosan/alcohol solutions according to the present invention are stable solutions that have antiviral, antibacterial and hemostatic effects. Likewise, the solutions have low toxicity compared to other solutions currently used as antiviral, anti-bacterial and hemostatic agents. Thus, the present solutions can be used in various ways without great concern of problems that may arise with prior art solutions when humans come into contact with these solutions. It is also believed that the anti-viral aspects of the chitosan solutions developed and formulated according to the present invention would be useful in combating such infections as HIV, herpes, or other sexually transmitted diseases (STDs). Section III further describes some of the various uses where the present solutions could be used.

### III. Uses and Products Incorporating the Solutions of the Present Invention

The antiviral & antibacterial qualities of the chitosan solutions developed according to the present invention have numerous uses at treating and killing bacteria and other microbes, as noted in section II. The solutions also can be contained and stored as liquids, which allows the solutions to be used in a variety of delivery devices. Following are examples of a few of these delivery devices, with section A. focusing on liquid chitosan/alcohol solutions and section B. focusing on chitosan gel solutions.

A. Liquid Chitosan/Alcohol Solutions

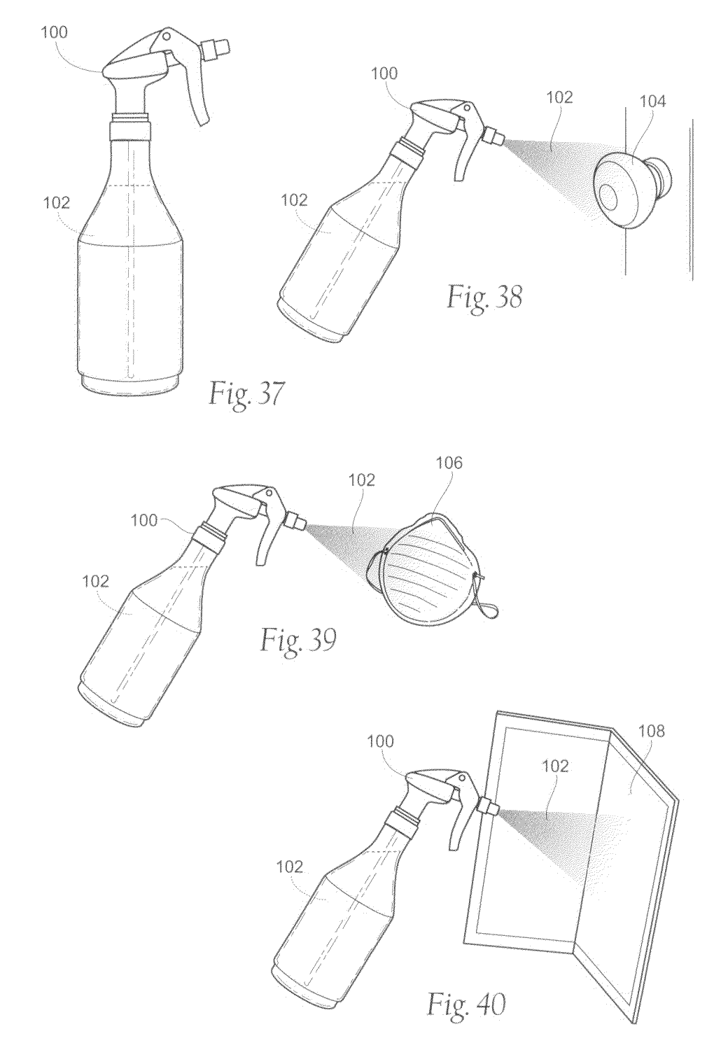

The chitosan/alcohol solutions produced according to section I.A and further described in section II.A have qualities that allow the solutions to be used as a spray for various uses. FIG. 37 provides a spray bottle 100 containing such an antiviral, antibacterial and hemostatic solution 102 developed according to the present invention. Such a spray bottle 100 is preferably formed of an opaque material that is tightly sealable to prevent dissipation of alcohol from the solution 102, which can affect the efficacy of the solution. That is, to prevent dissipation of alcohol from the solution, which can affect the efficacy of the solution, an opaque, sealable container is preferred to store and hold the solution.

FIG. 38 through FIG. 40 show the solution 102 being sprayed onto various inanimate objects. FIG. 38 depicts the solution 102 being sprayed on a door handle 104. FIG. 39 depicts the solution 102 being sprayed on a surgical mask 106. FIG. 40 depicts the solution 102 being sprayed on a menu 108. Spraying of the solutions 102 on these objects, and other inanimate objects, such as clothing, medical gowns and, medical suite surfaces (i.e. examination table) deposits a uniform, thin antibacterial and antiviral films onto the surface, providing the viral & bacterial prevention and inhibition, as discussed in section II, above.

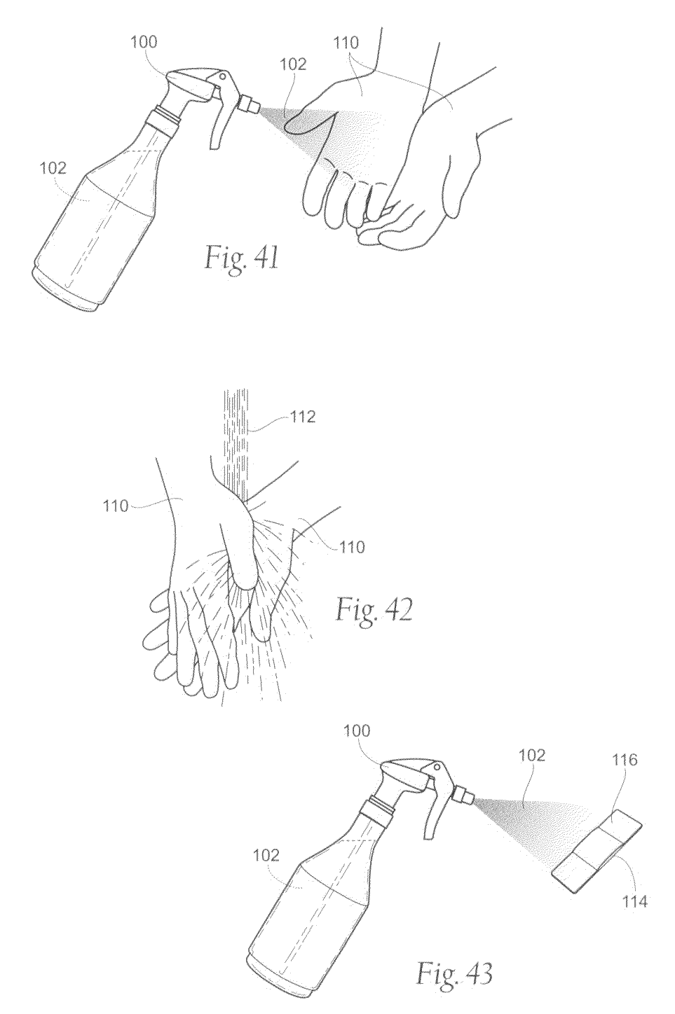

Likewise, solutions according to the present invention can be used directly on a person's skin and on dressings and the like that will come into contact with a person's skin. FIG. 41 provides such an example. The solution 102 is sprayed onto a person's hands 110, providing a thin, protective film, similar to that described for inanimate objects. Under normal activities, the film will stay on the person's hands 110 until being washed off with water 112 or the like, as depicted in FIG. 42.

FIG. 43 further demonstrates the utility of the solution by applying the solution directly to a medical dressing or bandage 114 and specifically to the nonwoven portion 116 of the bandage. This provides antiviral, antibacterial and hemostatic solutions that may be applied easily and cost-effectively to medical dressing 114. Such a process, either by direct spray or drop process, could be used in a medical dressing manufacturing assembly process to improve the quality of the bandages produced.

The solutions of the present invention also could be formulated as a gel solution and could be delivered as a gel. Such potential devices are contemplated in the following section.

B. Chitosan Gel Solutions and Delivery Devices

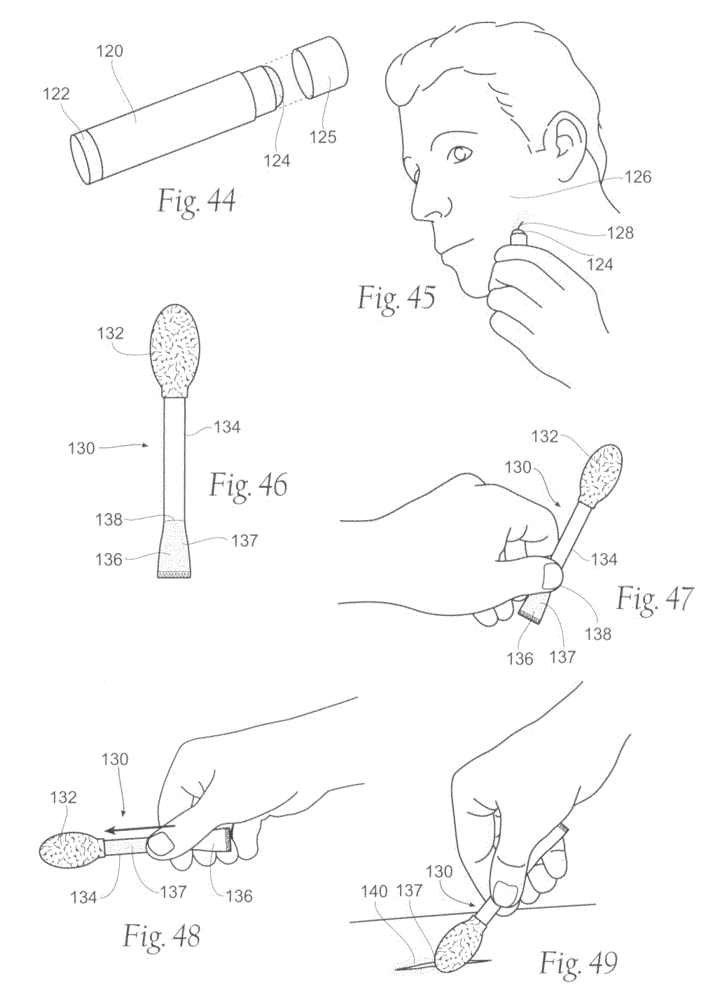

FIG. 44 shows a device 120 that is designed to deliver a chitosan solution 124 for therapeutic uses. The solution 124 depicted in FIG. 44 is a gel style chitosan solution, previously discussed in section I.B.2., above. The device 120 could have a screw style turning device 122 to push the solution out of the device 120, similar to the devices used for delivering chapstick, lip balm, or lipstick. A cap 125 is secured on the device 120 to protect the solution 124 from drying out when not being used. Because of the low concentrations of alcohol in the solutions of the present invention compared to alcohol concentrations of prior art devices, loss of alcohol due to evaporation would be more noticeable in the present invention. As such, the cap 125 is preferably sealable to minimize evaporation and dehydration processes for the solution 124 when the device 120 is not in use. It is understood that other similar devices could be used for the solution 124 delivery.

FIG. 45 demonstrates a practical use. for the device 120 shown in FIG. 44. A person, when shaving, may occasionally cut or nick his face 126, which will cause the cut 128 to bleed and irritate the person. By using the device 120, the person can apply the solution to the cut 128, thereby providing an antiviral & antibacterial layer of material to the cut 128 and minimize potential infections at the cut. Furthermore, the hemostatic qualities of the solution will assist in stopping the cut from bleeding. Other similar uses, such as using the device on the person's face 126 to treat acne, have been contemplated with the present invention.

FIGS. 46-49 demonstrate another device 130 that can be used to deliver a solution according to the present invention. The device 130 generally comprises a dabbing or applicator device, having an applicator portion 132 and a hollow shaft 134 that a person can use to grab the device 130 and apply a solution 137 to a wound 140 (see FIG. 49). The hollow shaft 134 is preferably fluidly connected to the applicator portion 132. The shaft 134 is further connected to a reservoir 136 that contains the solution 137 according to the present invention, with the shaft 134 normally being separated from the reservoir 136 by way of a divider 138. The reservoir 136 is designed and arranged to provide a sterile environment for the solution inside of the reservoir 136 until the solution is to be used.

In FIG. 47, a person applies pressure to the divider 138, causing the divider 138 to break and provide an open passage between the shaft 134 and the reservoir 136. The user then pushes solution 137 out of the reservoir 136 and into the hollow shaft 134, as shown in FIG. 48. Eventually, the solution 137 would be forced into the applicator portion 132 of the device, whereby the solution 137 could be applied to the wound 140, as shown in FIG. 49.

It should be understood that any of the described devices and similar devices could be used to apply a chitosan solution according to the present invention onto an area or object. Applications include direct application by swabbing, dabbing or spraying to traumatized tissue surfaces (such as burns, abrasions, perforations, cuts, lacerations) to reduce opportunistic infection and control minor bleeding. Application by swabbing, dabbing or spraying can be used to treat infections such as Staphylococcus vulgaris (acne), methicillin resistant Staphylococcus aureus, Acinetobacter baumannii and other bacterial infections. Application by swabbing, dabbing, spraying can be used to eliminate biofilm colonies such as those of Staphylococcus epidermidis.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. An antiviral, antibacterial and hemostatic solution comprising:
a chitosan material; and
an alcohol compound, said alcohol compound comprising up to about 35% v/v of the solution.

2. The solution according to claim 1, wherein said alcohol compound comprises between about 5% to 20% v/v of the solution.

3. The solution according to claim 1, wherein the alcohol compound comprises either an isopropyl alcohol compound or an ethyl alcohol compound.

4. The solution according to claim 1, further comprising a witch hazel compound.

5. The solution according to claim 1 having a pH between about 3.0 to 6.0.

6. An antiviral, antibacterial and hemostatic spray solution comprising:
a chitosan material having a degree of deacetylation equal to or greater than 75% deacetylated; and an alcohol compound.

7. The solution according to claim 6 wherein said chitosan material has a degree of deacetylation equal to or greater than 85% deacetylated.

8. The solution according to claim 7 wherein said chitosan material has a degree of deacetylation equal to or greater than 95% deacetylated.

9. The solution according to claim 6 wherein said chitosan material has a molecular weight of less than or equal to 500 kDa.

10. The solution according to claim 9 wherein said chitosan material has a molecular weight of less than or equal to 300 kDa.

11. A method of producing an antiviral, antibacterial and hemostatic solution comprising:
providing deionized water;
adding a chitosan material to said deionized water;
adjusting the pH of the solution between about 3.0 and 6.0; and
adding an alcohol compound to the solution.

12. The method according to claim 11 wherein said step of adjusting the pH of the solution comprises the step of adding an acid to the solution.

13. The method according to claim 12 wherein said step of adjusting the pH of the solution comprises the step of adding a base to the solution.

14. The method of claim 11, wherein the alcohol compound is selected from the group consisting of isopropyl alcohol and ethyl alcohol.

15. The method of claim 11, wherein the step of adjusting the pH further comprises adjusting the pH to between about 4.0 and 5.0.

16. A method for killing bacteria comprising:
providing a solution, said solution comprising:
an alcohol compound, said alcohol compound comprising between about 2%-35% v/v of the solution; and
a chitosan material, said chitosan material comprising between about 0.5% to 10% w/w of the solution; and
bringing said solution into contact of said bacteria.

17. The method according to claim 16 wherein said alcohol compound is either ethyl alcohol or isopropyl alcohol.

18. The method according to claim 16 wherein said solution has a pH between about 3.0 and 6.0.

19. The method according to claim 16 wherein said chitosan material has a degree of deacetylation greater than or equal to 75% deacetylated.

20. The method according to claim 16 wherein said chitosan concentration is between about 0.5%-2.0% w/v/

21. A device for delivering an antiviral, antibacterial and hemostatic compound to a surface, said device comprising:
a housing;
a reservoir containing said antiviral, antibacterial and hemostatic compound, said compound further comprising a chitosan material and a alcohol compound, said alcohol compound comprising between about 2%-35% v/v of said compound; and means for delivering said compound to said surface.

22. The device according to claim 21, wherein said compound comprises a gel, said gel comprising a chitosan material up to about 25% w/v of said compound, said chitosan being crosslinked with a multifunctional acid compound.

23. The device according to claim 21 wherein said housing further comprises a lip-balm style housing.

24. The device according to claim 21, wherein said compound comprises a liquid.

25. The device according to claim 21, wherein said housing further comprises a spray bottle.
